(19) United States
(12) Patent Application Publication
(10) Pub. No.: US 2026/0193860 A1
(43) Pub. Date: Jul. 9, 2026

(54) TRENCH DIGGER AND METHOD THEREFOR

(71) Applicant: Jon Humble, Saucier, MS (US)

(72) Inventor: Jon Humble, Saucier, MS (US)

(21) Appl. No.: 19/014,888

(22) Filed: Jan. 9, 2025

(51) Int. Cl. E02F 3/02; A01B 1/02; E02F 5/02

(52) U.S. Cl. CPC E02F 3/02; A01B 1/02; E02F 5/025

(57) ABSTRACT

A trench digger includes a pair of handles, a pair of plates, and a coupler. Each of the handles is elongated. Each of the handles is spaced apart and parallel to one another in an initial position. Each of the handles includes a first end and a second end. Each of the pair of plates is coupled to the second end of a respective one of the handles. Each of the pair of plates is flat. Each of the plates is spaced apart and parallel to one another when the handles are in the initial position to simultaneously cut opposing walls of a trench. The coupler pivotably connects the handles together such that the handles are relatively pivotable to selectively pivot the plates together to scoop up material removed from the opposing walls of the trench by the plates.

### (b) CROSS-REFERENCE TO RELATED APPLICATIONS

Not Applicable.

### (C) STATEMENT REGARDING FEDERALLY SPONSORED RESEARCH OR DEVELOPMENT

Not Applicable.

### (d) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### (f) STATEMENT REGARDING PRIOR DISCLOSURES BY THE INVENTOR OR JOINT INVENTOR

Not Applicable.

### (g) BACKGROUND OF THE INVENTION

### (1) Field of the Invention

The disclosure relates to trench diggers and more particularly pertains to a new trench digger for simultaneously cutting two straight walls of a trench and removing the dirt and other material cut from the walls. Trench diggers or trenchers have a single blade for cutting a section of a straight wall in the ground. This process is repeated to form two straight walls. A shovel is then used to dig out the separated material. The new trench digger has two pivotable arms and flat plates that can simultaneously cut on both sides of the trench, and then be pivoted together to scoop out the material, such as grass, dirt, and rocks. The new trench digger can be used with other materials, such as ice and snow, or could be used for other purposes, such as edging in lawns and gardens.

### (2) Description of Related Art Including Information Disclosed Under 37 CFR 1.97 and 1.98.

The prior art relates to traditional single-blade trenchers and curved blade post hole diggers. The prior art, as best understood, does not disclose a trench digger that has a pair of flat heads for simultaneously digging two straight sides of a trench, which flat heads are pivotable together to remove material separated from the sides of the trench.

### (h) BRIEF SUMMARY OF THE INVENTION

An embodiment of the disclosure meets the needs presented above in a trench digger generally comprising a pair of handles, a pair of plates, and a coupler. Each of the handles is elongated. Each of the handles is spaced apart and parallel to one another in an initial position. Each of the handles includes a first end and a second end. Each of the pair of plates is coupled to the second end of a respective one of the handles. Each of the pair of plates is flat. Each of the plates is spaced apart and parallel to one another when the handles are in the initial position to simultaneously cut opposing walls of a trench. The coupler pivotably connects the handles together such that the handles are relatively pivotable to selectively pivot the plates together to scoop up material removed from the opposing walls of the trench by the plates.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a trench digger according to an embodiment of the disclosure.

FIG. 2 is a close-up perspective view of a component of an embodiment of the disclosure.

FIG. 3 is a close-up side view of a component of an embodiment of the disclosure.

FIG. 4 is a close-up side view of a component of an embodiment of the disclosure.

FIG. 5 is a side view of an embodiment of the disclosure in use.

### (j) DETAILED DESCRIPTION OF THE INVENTION

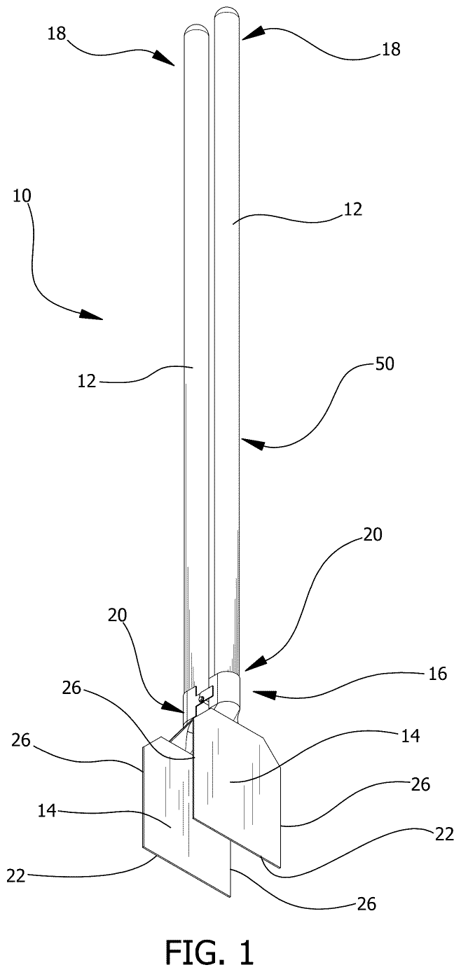

With reference now to the drawings, and in particular to FIGS. 1 through 5 thereof, a new trench digger embodying the principles and concepts of an embodiment of the disclosure and generally designated by the reference numeral 10 will be described.

As best illustrated in FIGS. 1 through 5, the trench digger 10 generally comprises a pair of handles 12, a pair of plates 14, and a coupler 16. Each of the handles 12 is elongated. Each of the handles 12 is spaced apart and parallel to one another in an initial position 50. Each of the handles 12 includes a first end 18 and a second end 20. Each of the pair of plates 14 is coupled to the second end 20 of a respective one of the handles 12. Each of the pair of plates 14 is flat. Each of the plates 14 is spaced apart and parallel to one another when the handles 12 are in the initial position 50 to simultaneously cut opposing walls 62 of a trench 60. The coupler 16 pivotably connects the handles 12 together such that the handles 12 are relatively pivotable to selectively pivot the plates 14 together to scoop up material removed from the opposing walls 62 of the trench 60 by the plates 14.

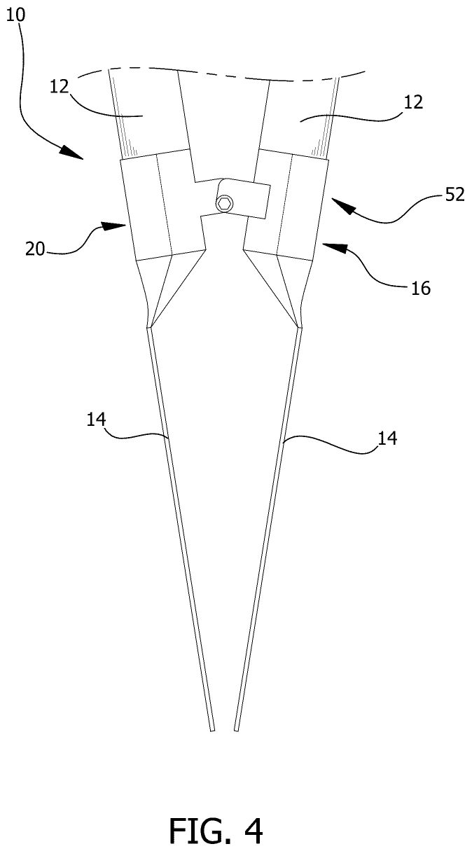

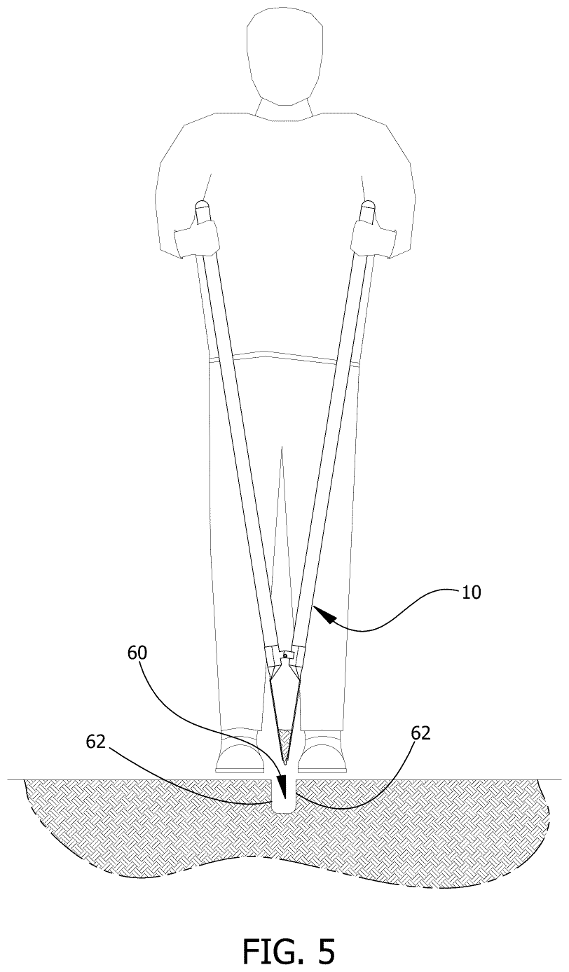

Each of the plates 14 includes a cutting edge 22 positioned distally from the second end 20 of a respective one of the handles 12. The cutting edges 22 are positioned to be brought close together when the plates 14 are pivoted together into a scooping position 52, as shown in FIGS. 4 and 5. The plates 14 could be pivoted such that the cutting edges 22 meet or are a close distance apart, which movement could depend on the material being removed.

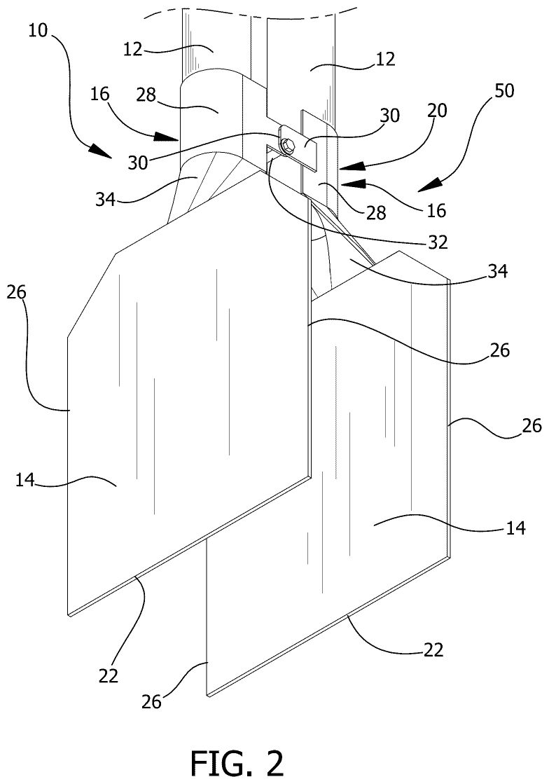

As shown in FIG. 2, the cutting edge 22 of each of the plates 14 is straight and oriented perpendicular to a central longitudinal axis 24 of a respective one of the handles 12. Each of the plates 14 includes a pair of side edges 26 that are straight and extend perpendicular to the cutting edge 22.

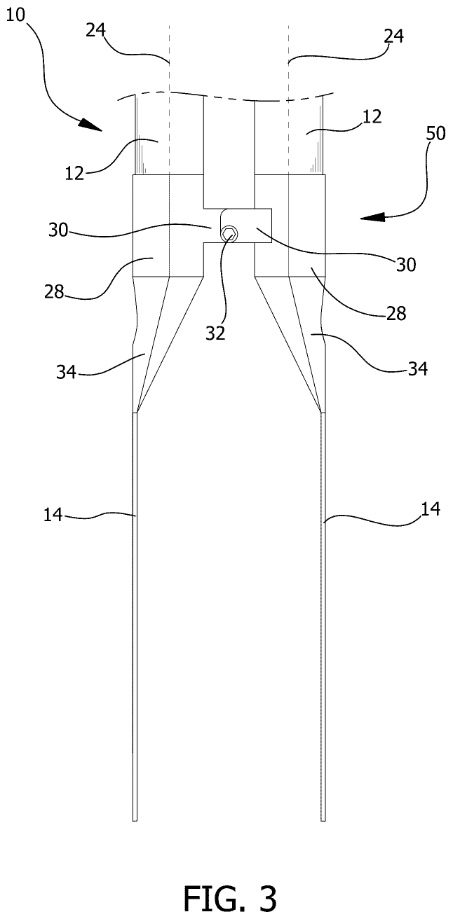

As shown in FIG. 3, each of the plates 14 is positioned offset with respect to the central longitudinal axis 24 of a respective one of the handles 12 such that the plates 14 are spaced further apart than the handles 12 in the initial position 50.

The coupler 16 includes a pair of brackets 28 positioned about a portion of the second end 20 of a respective one of the handles 12. The coupler 16 includes two pairs of pivot arms 30. Each of the two pairs of pivot arms 30 is positioned to extend from a respective one of the brackets 28. The coupler 16 includes a pivot pin 32 that pivotably connects the two pairs of pivot arms 30. Other pivot connections could be used that are well known in the mechanical arts.

The trench digger 10 further includes a pair of connectors 34. Each of the connectors 34 extends from a respective one of the brackets 28 and is attached to a respective one of the plates 14. In another possible embodiment, the connectors 34 could be separate from the brackets 28 and attached directly to the handles 12. In another possible embodiment, the connectors 34 could be omitted and the plates 14 could be mounted in the handles 12. As shown in FIG. 4, each of the connectors 34 is angled to achieve the offset positioning of the plates 14 with respect to the central longitudinal axis 24 of each of the handles 12.

The handles 12 are made of fiberglass, though in other embodiments the handles 12 could be made of metal, plastic, or wood. The plates 14 are made of steel, though in other embodiments the plates 14 could be made of different types of metal, ceramic, or plastic. The plates 14 can be of various sizes as desired, such as in the range of 8 to 16 inches in diameter, and the handles 12 can be of various lengths, such as in the range of 3 to 6 feet long. The plates 14 can be rectangular or square, or possibly other shapes, and could include sharp corners or chamfers or a combination thereof, as shown in the exemplary embodiment in FIG. 2.

FIG. 5 shows the use of the trench digger 10 in digging a trench 60. While not shown in FIG. 5, the user first holds the handles 12 in the initial position 50 (shown in FIG. 1) over a section of ground. The user then presses the handles 12 downwardly and drives the plates 14 into the ground, thereby simultaneously cutting opposing walls 62 of the trench 60. Then, as shown in FIG. 5, the user pivots the handles 12 apart and thereby moves the plates 14 together into the scooping position 52. This movement results in the user scooping up material, such as dirt, rocks, and grass, removed from the opposing walls 62 of the trench 60 with the plates 14. These steps can be repeated with adjacent sections of ground until the trench 60 has a desired length. While this example is for a trench 60, the trench digger 10 could also be used for edging lawns and gardens, removing ice and snow, or other possible uses.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trench digger comprising:
a pair of handles, each of said handles being elongated, said handles being spaced apart and parallel to one another in an initial position, each of said handles including a first end and a second end;
a pair of plates, each of said pair of plates being coupled to said second end of a respective one of said handles, each of said pair of plates being flat, said plates being spaced apart and parallel to one another when said handles are in the initial position to simultaneously cut opposing walls of a trench; and
a coupler pivotably connecting said handles together such that said handles are relatively pivotable to selectively pivot said plates together to scoop up material removed from the opposing walls of the trench by said plates.

2. The trench digger of claim 1, wherein:
each of said plates includes a cutting edge positioned distally from said second end of a respective one of said handles; and
said cutting edges are positioned to be brought close together when said plates are pivoted together.

3. The trench digger of claim 2, wherein said cutting edge of each of said plates is straight and oriented perpendicular to a central longitudinal axis of a respective one of said handles.

4. The trench digger of claim 3, wherein each of said plates includes a pair of side edges that are straight and extend perpendicular to said cutting edge.

5. The trench digger of claim 1, wherein each of said plates is positioned offset with respect to a central longitudinal axis of a respective one of said handles such that said plates are spaced further apart than said handles in the initial position.

6. The trench digger of claim 1, wherein:
said coupler includes a pair of brackets positioned about a portion of said second end of a respective one of said handles;
said coupler includes two pairs of pivot arms;
each of said two pairs of pivot arms is positioned to extend from a respective one of said brackets; and
said coupler includes a pivot pin pivotable connecting said two pairs of pivot arms.

7. The trench digger of claim 1, further including a pair of connectors, each of said connectors extending from a respective one of said brackets and being attached to a respective one of said plates.

8. The trench digger of claim 7, wherein each of said connectors is angled to position a respective one of said plates offset with respect to a central longitudinal axis of a respective one of said handles such that said plates are spaced further apart than said handles in the initial position.

9. The trench digger of claim 4, wherein:
said coupler includes a pair of brackets positioned about a portion of said second end of a respective one of said handles;
said coupler includes two pairs of pivot arms;
each of said two pairs of pivot arms is positioned to extend from a respective one of said brackets; and
said coupler includes a pivot pin pivotable connecting said two pairs of pivot arms.

10. The trench digger of claim 9, further including a pair of connectors, each of said connectors extending from a respective one of said brackets and being attached to a respective one of said plates.

11. The trench digger of claim 10, wherein each of said connectors is angled to position a respective one of said plates offset with respect to the central longitudinal axis of a respective one of said handles such that said plates are spaced further apart than said handles in the initial position.

12. A method of digging a trench comprising the steps of:
providing a trench digger comprising:
a pair of handles, each of said handles being elongated, said handles being spaced apart and parallel to one another in an initial position, each of said handles including a first end and a second end;
a pair of plates, each of said pair of plates being coupled to said second end of a respective one of said handles, each of said pair of plates being flat, said plates being spaced apart and parallel to one another when said handles are in the initial position to simultaneously cut opposing walls of a trench; and
a coupler pivotably connecting said handles together such that said handles are relatively pivotable to selectively pivot said plates together to scoop up material removed from the opposing walls of the trench by said plates;
holding said handles in the initial position over a section of ground;
pressing said handles downwardly and driving said plates into the ground;
simultaneously cutting opposing walls of the trench;
pivoting said handles apart and thereby moving said plates together;
scooping up material removed from the opposing walls of the trench with said plates; and
selectively repeating said steps with adjacent sections of ground until the trench has a desired length.
